(19) United States
(12) Patent Application Publication
(10) Pub. No.: US 2017/0143019 A1
(43) Pub. Date: May 25, 2017

(54) DRIED FOOD PRODUCT AND METHOD FOR MAKING THE SAME

(71) Applicant: Link Snacks, Inc., Minong, WI (US)

(72) Inventors: Zach Robertson, White Bear Lake, MN (US); Tim Johnson, Excelsior, MN (US); Brian Carter, Prior Lake, MN (US)

(21) Appl. No.: 15/355,655

(22) Filed: Nov. 18, 2016

Related U.S. Application Data
(60) Provisional application No. 62/257,586, filed on Nov. 19, 2015.

(51) Int. Cl. A23L 13/40; A23L 13/70

(52) U.S. Cl. CPC A23L 13/42; A23L 13/70; A23L 13/428; A23V 2002/00

(57) ABSTRACT

A dried food product is prepared from two or more protein sources. The protein sources may include muscle meats and vegetable protein sources. The method for preparing the dried food product includes size reduction, mixing, and drying.

### RELATED APPLICATIONS

This application claims priority to Provisional Application No. 62/257,586 filed on Nov. 19, 2015, which is incorporated by reference herein in its entirety.

### FIELD

The present disclosure relates to dried food products including two or more sources of protein and to methods for making the dried food products.

### BACKGROUND

Dried ready-to-eat (RTE) food products known as “jerky” are typically produced from muscle meat that is trimmed of fat, seasoned, cut into pieces, and dried to a low moisture content that prevents spoilage. Alternatively jerky can be produced by grinding the meat and pressing, extruding, or rolling ground meat into a flat sheet prior to drying. The USDA (U.S. Department of Agriculture) requires that meat products labelled “jerky” must have a moisture-to-protein ratio of 0.75:1 or less, and recommends a water activity (a_{w}) of 0.80 or less. Jerky is most commonly produced from beef or poultry, but other common protein sources for jerky include venison, pork, bison, lamb, fish, and other meats suitable for human consumption. It is against this background that the present disclosure is made.

### SUMMARY

A dried food product prepared from two or more protein sources and methods for making the same are disclosed. The protein sources may include muscle meats and vegetable protein sources.

### BRIEF DESCRIPTION OF DRAWINGS

FIG. 1A is a schematic flow diagram of the method of making the food product according to an embodiment.

FIG. 1B is a schematic flow diagram of an exemplary embodiment of the method of FIG. 1A.

### DETAILED DESCRIPTION

The present disclosure relates to food products having at least a first protein source and a second protein source, where the food products have a texture similar to beef jerky products. The present disclosure further relates to food products that are suitable for human consumption. Food products prepared in accordance with compositions and methods of the present disclosure may be referred to as, for example, sliced, chunked, ground, formed, and/or shaped jerky.

According to some embodiments, the food products of the present application are prepared using muscle meat that is suitable for human consumption. The muscle meat may be sourced from beef, venison, bison, pork, chicken, turkey, lamb, fish, or seafood. For the purposes of the present application, the term muscle meat is used to refer to skeletal meat and does not include substantial amounts of other meat products or meat by-products. Other meat products are understood to mean, for example, the tongue and heart of an animal. Meat by-products are understood to mean organs and other tissues, such as liver, kidneys, lungs, brain, intestines, bone, and skin. At least in some embodiments, the food products of the present application are free or substantially free of other meat products and meat by-products.

The term “substantially free” is used here to indicate that no substantial amounts (e.g., no more than incidental amounts, such as about 0.1%, about 0.5%, about 1%, about 2%, about 3%, or about 5%) of the component are included in the product.

The term “about” is used here in conjunction with numeric values to include normal variations in measurements as expected by persons skilled in the art, and is understood have the same meaning as “approximately” and to cover a typical margin of error, such as ±5% of the stated value.

As used here, the terms “percent” and “%”are intended to be synonymous with “weight percent” and “wt-%” unless specifically otherwise indicated, and refer to the concentration of a substance by weight of the substance relative to the total weight of the composition.

The phrase “suitable for human consumption” is used here to refer to food products that meet any applicable USDA requirements for human food.

According to an embodiment, the food product comprises muscle meat sourced from at least two or more different sources of protein suitable for human consumption. The proteins used in the food product are collectively referred to as “protein sources” here. For example, the protein sources may include protein (e.g., muscle meat) from two or more of beef, pork, chicken, turkey, venison, bison, lamb, fish or seafood. The food product may include combinations, such as beef and pork; beef and turkey; beef, pork, and turkey; beef, chicken, and turkey; beef and lamb; pork and turkey; pork and lamb; or any combination of the suitable protein sources. The food product may also include other protein sources in addition to muscle meat. For example, the food product may include eggs, dairy, casein, whey, or vegetable or plant proteins, such as protein from soy beans (e.g., tofu), other beans, or peas. Vegetable proteins may also include textured vegetable proteins, such as textured vegetable protein produced from soy protein. However, in preferred embodiments, the food product does not include non-muscle-meat animal proteins other than whey and egg. In some embodiments, the food product is free of or substantially free of any non-muscle-meat proteins. The food product may include less than about 30%, about 20%, about 15%, about 10%, about 8%, about 6%, or less than about 5% of non-muscle-meat ingredients (either proteins or otherwise). In some embodiments, the food product includes from about 2 to about 40%, from about 3 to about 35%, from about 4 to about 30%, or from about 5 to about 25% additional ingredients that may include salt, sugar, flavorings, water, humectants, binders, curing agents, or a combination thereof.

The food product can be produced from a mixture containing protein sources and other ingredients. In some embodiments, the mixture comprises protein sources, salt, and optionally flavorings, sugar, water, humectants, binders, and curing agents. The mixture may comprise about 5 to about 95%, about 8 to about 90%, or about 10 to about 85% of protein sources by weight of the mixture. Typically plant-based proteins are available as dry powders and are mixed with water to hydrate the protein powder. Therefore, mixtures that are made with plant-based proteins typically include a lower percentage of protein sources and higher percentage of water. For example, if the mixture is made primarily with plant-based protein, it may include about 0.1 to about 50%, about 2 to about 40%, or about 5 to about 30% of protein sources, and a sufficient amount of water to hydrate the plant proteins. In an exemplary embodiment, the mixture is made with about 5% plant protein (e.g., soy protein), about 90% water, and about 5% additional ingredients (e.g., salt and flavorings). When the mixture is made with muscle meat as the primary protein source, the amount of protein source may range from about 40 to 95 wt-%, or about 50 to about 90 wt-%, or about 60 to about 85 wt-%. The amount of protein sources can be adjusted when the mixture is made with a combination of different protein sources, including plant and muscle-meat sources.

In this context, the protein source is understood to include moisture, such as the natural moisture content present in meats. For example, a typical skeletal muscle protein source includes about 55 to about 75% water and about 20 to about 30% protein, depending on the source and the quality of the meat. The amount of protein sources in the mixture may be composed of two or more protein sources. For example, the mixture may include from 0 to about 70 wt-% of a first protein source, from 0 to about 70 wt-% of a second protein source, from 0 to about 70 wt-% of a third protein source, from 0 to about 70 wt-% of a fourth protein source, etc. In one exemplary embodiment, the mixture includes from about 30 to about 60 wt-% of beef and from about 20 to about 50 wt-% pork.

The mixture may comprise about 0.3 to 6.5 wt-%, about 0.5 to 5 wt-%, about 0.75 to 4 wt-%, or about 1 to 3 wt % salt. For example, the mixture may comprise about 2 wt-% salt. Examples of suitable salts include sodium salts, potassium salts, magnesium salts, manganese salts, and mixtures thereof. Commercially available forms of salt include table salt, iodized table salt, kosher table salt, sea salt, fleur de sel, smoked salt, and finishing salt. While the salt contributes to the curing of meats, the mixture may further include one or more additional curing agents. Examples of suitable curing agents include nitrites (e.g., sodium nitrite, potassium nitrite), nitrates (e.g., sodium nitrate, potassium nitrate), or natural curing agents (e.g., commercially available products, such as those derived from spinach, swiss chard, or celery powder). Curing agents may be included in the mixture at a concentration of about 0 to about 2 wt-%, about 0.1 to about 1 wt-%, or about 0.3 to about 0.8 wt-%.

The mixture may also include sugar and various flavorings depending on the target flavor of the food product. For example, the mixture may include up to 40 wt-% sugar, or about 0.5 to about 30 wt-%, about 5 to about 28 wt-%, about 8 to about 25 wt-%, or about 20 to about 35 wt-% sugar. The mixture may be flavored with various flavorings, such as herbs, spices, extracts, oils, and other seasonings and flavors. Examples of flavorings include herbs, such as oregano, basil, thyme, marjoram; spices such as black pepper, red pepper, chili peppers, cayenne, cumin, aniseed, paprika, ginger; and other flavors, such as soy sauce, garlic, onion, smoke flavor, mustard, tomato, lemon, lime, etc. The mixture can be flavored with marinades or rubs, such as barbeque sauce or rub, teriyaki sauce, or any other suitable combination of flavorings. The mixture may include up to about 15 wt-% of flavorings, or about 0.01 to about 12 wt-%, about 0.5 to about 10 wt-%, about 1 to about 8 wt-%, or about 2 to about 7 wt-% flavorings.

The mixture may further include one or more humectants. In embodiments that include sugar, the sugar also acts as a humectant. The mixture may also include other food grade humectants, such as glycerol, at a concentration of up to 1.5 wt-% based on the weight of the wet mixture. The final (dried) product may therefore include about 2.5 to 3 wt-% of humectant.

The mixture may optionally include a binder. Suitable binders include, for example, whey, fibers, and starches. Some binders, such as whey, may act both as a binder and a protein source. The mixture may include up to 3.5 wt-% of a binder, or up to about 3 wt-%, 2.5 wt-%, 2 wt-%, 1.5 wt-%, or 1 wt-%. However, in some embodiments the mixture does not include a binder, or only includes a binder that can also act as a protein source. In some embodiments the food product is free of starch-based binders.

According to an embodiment, the mixture (before drying) has a moisture content of about 40 to about 80 wt-%, or about 50 to about 70 wt-%, and a protein content of about 10 to about 50 wt-%, or about 20 to about 40 wt-%. Mixtures prepared primarily from plant-based protein sources may have a higher moisture content prior to drying, such as about 75 to about 95 wt-%, or about 80 to about 90 wt-%, and a protein content of about 5 to about 20 wt-%. Mixtures prepared from a combination of protein sources, including both plant and muscle-meat based sources, may have a moisture content of about 40 to about 90 wt-%, and a protein content of about 10 to about 40 wt-% prior to drying. The mixture may include added water, particularly if the mixture includes vegetable-based protein sources. Exemplary formulations of the mixture are shown in TABLE 1 below.

TABLE 1
Mixture composition before drying.

| | General | | |
|---|---|---|---|
| | Compo- | | |
| | sition | Example A | Example B |
| Component | (wt-%) | (wt-%) | (wt-%) |
| Animal Protein | 0-70 | 60 | 40 |
| Source #1 (e.g., Pork) | | | |
| Animal Protein | 0-70 | 20 | 40 |
| Source #2 (e.g., Beef) | | | |
| Animal Protein | 0-70 | | |
| Source #3 (e.g., Chicken) | | | |
| Animal Protein | 0-70 | | |
| Source #4 | | | |
| Plant Protein | 0-70 | | |
| Source #1 | | | |
| Plant Protein | 0-70 | | |
| Source #2 | | | |
| Plant Protein | 0-70 | | |
| Source #3 | | | |
| Salt | 0.5-4 | 1.5 | 1.75 |
| Sugar | 0-20 | 12 | 14 |
| Flavorings | 0-10 | 2.5 | 1.25 |
| Water | 0-40 | 3.5 | 2.5 |
| Humectant | 0-1.5 | | |
| Binder | 0-3.5 | | |
| Curing Agents | 0-1 | 0.5 | 0.5 |

According to some aspects, the finished (dried) food product has a moisture-to-protein ratio of 0.75 parts or less of moisture for every 1 part of protein, such as about 0.70 to about 0.73 parts or less of moisture for every 1 part of protein. The dried food product may have a moisture content of about 15 to about 45 wt-%, about 20 to about 40 wt-%, about 21 to about 35 wt-%, or about 22 to about 30 wt-%. In some embodiments the food product has a protein content of at least 30 wt-%, or from about 31 to about 60 wt-%, about 32 to about 50 wt-%, or from about 35 to about 45 wt-%.

The presence of free water in the product can also be measured as water activity. In some embodiments, the food product has a water activity of about 0.90 or less, or from about 0.50 to about 0.90, from about 0.60 to about 0.85, or from about 0.70 to about 0.82. In foods intended for human consumption, the water activity is preferably about 0.6 or higher. Products with water activity of less than 0.6 are typically found to be too dry, and have a dry, brittle, stringy, or non-appealing texture and reduced flavor.

Some ingredients, such as salt, sugar, curing agents, and some curing methods, such as smoking, may provide the food product with a preservative function. However, at least in some embodiments, the food product is free of added preservatives, or includes less than 1%, less than 0.75%, less than 0.5%, less than 0.2%, or less than 0.1% of added preservatives. Suitable added preservatives include, for example, ascorbic acid, benzoic acid, citric acid, sorbic acid, sodium sorbate, potassium sorbate, sodium nitrite, potassium nitrite, sodium nitrate, potassium nitrate, and combinations thereof.

The food product may have a fat content of about 0 to about 15%, from about 0 to about 10%, from about 1 to about 8%, or from about 3 to about 7% based on the weight of the food product.

According to some aspects, the food product does not include significant amounts of dietary fiber. For example, the food product may include less than about 5%, less than about 4%, less than about 3%, less than about 2%, or less than about 1% dietary fiber.

The food product may include sugar at about 1 to about 40 wt-%, about 5 to about 35 wt-%, about 8 to about 30 wt-%, or about 15 to about 25 wt-% by weight of the food product; salt at about 1 to about 5%, about 1.5 to about 4.5%, about 2 to about 4%, or about 2.5 to about 3.8% by weight of the food product; and flavorings at 0 to about 5%, about 0.5 to about 4%, or about 1.0 to about 3% by weight of the food product.

Method

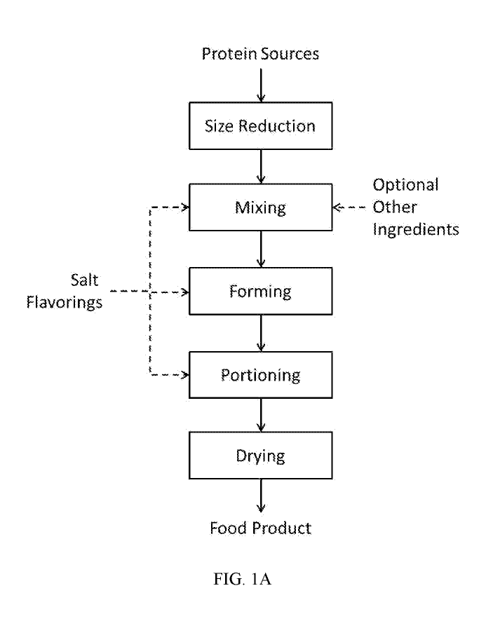

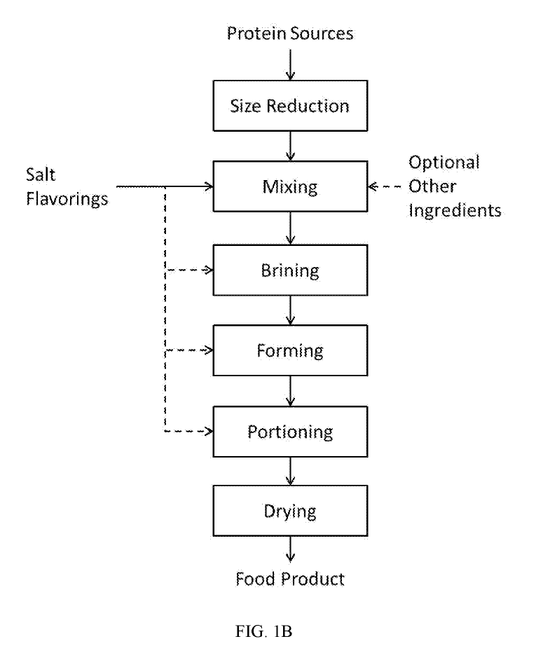

The food product can be produced from a mixture of ingredients including two or more protein sources and optionally additional ingredients. A simplified flow diagram of the process is shown in FIG. 1A. Further, an exemplary process is shown in FIG. 1B. After suitable protein sources are selected and optionally pre-processed (e.g., having bones, skin, connective tissues, and excess fat removed), the process begins with size reduction of the protein sources. Size reduction may include slicing, chunking, sectioning, grinding, or milling. However, it is preferred that the whole muscle character of the protein sources be preserved to the extent possible. The protein source is then mixed and optionally blended with other ingredients, such as salt, sugar, curing agents, flavorings, humectants, binder, water, or combinations thereof.

As shown in the exemplary process in FIG. 1B, the mixture can undergo a brining or marinating step, during which the meat is cured and absorbs flavors. If the product is to include a binder, the binder can be added prior to the forming and portioning. If the binder is added after brining, the process can include an additional mixing step. Salt and other flavorings can be added before or during the brining step, and can be further added later in the process. According to at least some aspects, the mixture is not fermented, and does not include an added acidulant. The pH of the mixture and of the final product is about 5 to about 7, or about 5.5 to about 6.5, or about 5.9 to about 6.1, or about 6.

The mixture of protein sources and other ingredients can be formed and portioned into suitable size portions that can be dried to meet the USDA requirement of moisture to protein ratio for jerky of 0.75 parts or less of moisture for every 1 part of protein.

Forming and portioning can include, for example, rolling, sheeting, extruding, cutting, molding, or other suitable methods to achieve the desired size. The forming and portioning may also be performed in a single step, or in a reverse order from that shown in the figures. In some embodiments, the mixture is formed and portioned prior to drying. In other embodiments, the mixture is formed and dried, and portioned after drying. In preferred embodiments, the mixture is not enclosed in a casing or a cover.

In some embodiments, the mixture is heated before, during, or after drying. The mixture may be heated to an internal temperature that is sufficient to reduce any potential microbiological load in the mixture. Preferably, the mixture is heated so that the microbiological load is reduced by at least a 5-log reduction, or by at least a 4-log reduction. For example, the mixture can be heated to an internal temperature of about 130° F. for about 121 min or longer. If the temperature is increased to higher than 130° F., the heating time can be decreased respectively. For example, if the mixture is heated to an internal temperature of 160° F., the temperature does not need to be held for an extended period of time (e.g., the temperature can be held for a few seconds, such as about 1 to about 60 seconds, only).

The mixture can be dried at a temperature of about 110° F. to about 275° F., about 120° F. to about 250° F., or about 130° F. to about 225° F., and at a relative humidity of about 25 to about 75%, or about 30 to about 70%.

In one exemplary embodiment, the mixture is dried in a drying chamber in a first drying step, during which proteins in the mixture can bind to each other, improving cohesion of the mixture. The first drying step can be performed at ambient or slightly elevated temperature, such as, for example, about 80 to about 135° F., or about 90 to about 120° F. After the first drying step, the mixture may be smoked to impart a desired flavor to the mixture, and also to provide an antioxidant and antimicrobial effect. The smoking step may be conducted at a similar temperature as the first drying step, about 80 to about 135° F., or about 90 to about 120° F. After the first drying step (and optionally the smoking), the temperature of the drying chamber can be raised gradually to about 140 to about 210° F. For example, the temperature of the drying chamber can be first raised to a temperature of about 140 to about 175° F. for a first period of time, and then to about 160 to about 210° F. for a second period of time. During the second period of time, the relative humidity of the chamber may be increased to flash-cook the mixture. The moisture may then be vented out of the chamber, allowing the mixture to further dry at the elevated temperature.

The mixture is dried to a moisture-to-protein ratio of 0.75 parts or less of moisture for every 1 part of protein, such as about 0.70 to about 0.73 parts or less of moisture for every 1 part of protein. In some embodiments the food product has a protein content of at least 30 wt-%, or from about 35 to about 65 wt-%, about 40 to about 60 wt-%, or from about 45 to about 55 wt-%. The dried food product may have a moisture content of about 15 to about 45 wt-%, about 20 to about 40 wt-%, about 21 to about 35 wt-%, or about 22 to about 30 wt-%.

The dried food product has a water activity of about 0.90 or less, or from about 0.50 to about 0.90, from about 0.60 to about 0.85, or from about 0.70 to about 0.82. The water activity of the finished food product is preferably about 0.6 or higher.

The food product may have a fat content of about 0 to about 15%, from about 0 to about 10%, from about 0.5 to about 5%, or from about 1 to about 4% based on the weight of the food product.

According to some aspects, the food product does not include significant amounts of dietary fiber. For example, the food product may include less than about 5%, less than about 4%, less than about 3%, less than about 2%, or less than about 1% dietary fiber.

The product can be packaged in modified atmosphere packaging. The modified atmosphere packaging may include an inert gas atmosphere (e.g., an atmosphere high in nitrogen, carbon dioxide, or a combination thereof), where the amount of inert gases inside the package have been increased and the amount of oxygen has been decreased, and packaging that is substantially non-permeable to gases. For example, the product can be packaged in packaging that together with the modified atmosphere and the properties of the food product (e.g., moisture content, water activity, and salt content) provides the food product with a shelf life of at least 6 months, at least 12 months, or preferably about 14 to about 24 months or about 16 to about 22 months. The packaging can include a plastic bag, a plastic container, or a plastic-lined or foil-lined bag or container. At least in some embodiments, the food product is packaged as loose pieces of dried jerky inside the packaging without a casing to cover or hold together the pieces of food.

### EXAMPLES

### Example 1

Samples of dried food products were prepared from beef and pork at various ratios of protein sources. Sample 1 (control) included only beef; sample 2 included pork and beef at a ratio of 50:50; sample 3 included pork and beef at a ratio of 70:30; and sample 4 included only pork. The samples also included salt and flavorings.

The samples were prepared according to the method of the present disclosure, and were tested by taste testers in a randomized taste testing. In addition to flavor and texture, the samples were also rated for appearance.

It was found that there were no significant differences in the overall ratings between the four samples. Sample 3 rated higher on flavor than Samples 1, 2, and 4. Sample 2 rated higher for overall appearance ratings than Samples 1, 3 and 4. All samples rated similarly for texture with no significant differences in ratings.

While certain embodiments of the invention have been described, other embodiments may exist. While the specification includes a detailed description, the invention's scope is indicated by the following claims. The specific features and acts described above are disclosed as illustrative aspects and embodiments of the invention. Various other aspects, embodiments, modifications, and equivalents thereof which, after reading the description herein, may suggest themselves to one of ordinary skill in the art without departing from the spirit of the present invention or the scope of the claimed subject matter.

1. A dried food product comprising:
a first source of protein;
a second source of protein different from the first source of protein, the first and second sources of protein being selected from beef, pork, chicken, turkey, venison, bison, lamb, fish or seafood;
the dried food product having a moisture content of about 18 to about 30%, a fat content of less than about 12%, and a moisture-to-protein ratio of 0.75 parts or less of moisture for every 1 part of protein.

2. The dried food product of claim 1, wherein the first source of protein is beef.

3. The dried food product of claim 1, wherein the first source of protein is pork.

4. The dried food product of claim 1 further comprising a third source of protein of plant origin.

5. The dried food product of claim 1 further comprising flavorings, sugar, water, humectants, binders, curing agents, or a combination thereof.

6. The dried food product of claim 1, wherein the dried food product comprises from about 35 to about 65 wt-% protein.

7. The dried food product of claim 1, wherein the dried food product has a water activity of about 0.5 to about 0.9.

8. The dried food product of claim 1, wherein the dried food product has a water activity of about 0.6 to about 0.85.

9. The dried food product of claim 1, wherein the dried food product is not encased in a casing.

10. A packaged food product comprising:
a dried food product having a moisture content of about 18 to about 30% and a moisture-to-protein ratio of 0.75 parts or less of moisture for every 1 part of protein, the dried food product comprising a mixture of:
a first source of protein; and
a second source of protein different from the first source of protein, the first and second sources of protein being selected from beef, pork, chicken, turkey, venison, bison, lamb, fish or seafood;
modified atmosphere packaging,
the packaged food product having a shelf life of about 12 to about 24 months.

11. A method for making a dried food product comprising:
cutting and mixing a first protein source and a second protein source different from the first protein source to form a mixture;
forming a portion of the mixture into a unit; and
heating the unit to reduce a microbiological load in the unit by at least a 4-log reduction and to dry the unit to a moisture content of about 20 to about 40% and a moisture-to-protein ratio of 0.75 parts or less of moisture for every 1 part of protein.

12. The method of claim 11, wherein the forming comprises rolling, sheeting, extruding, cutting, molding, or combinations thereof.

13. The method of claim 11, wherein the mixture is not enclosed in a casing or a cover.

14. The method of claim 11, wherein the first and second protein sources are selected from beef, pork, chicken, turkey, venison, bison, lamb, fish, seafood, and plant-based proteins.

15. The method of claim 11, wherein the unit is heated to an internal temperature of about 130° F. for about 121 min or longer.

16. The method of claim 11, wherein the unit is heated to an internal temperature of about 160° F. for about 1 to about 60 seconds.

17. The method of claim 11, wherein the heating the unit comprises a first drying step at a temperature of about 80 to about 135° F., and a second drying step at a temperature of about 140 to about 210° F.

18. The method of claim 11 further comprising smoking the unit.

19. The method of claim 11, wherein the dried food product has a water activity of about 0.55 to about 0.85.

20. The method of claim 11, wherein the dried food product has a fat content of about 1 to about 10%.

21. The method of claim 11 further comprising packaging the dried food product in modified atmosphere packaging.

22. The method of claim 11 further comprising mixing additional ingredients comprising salt, sugar, flavorings, water, humectant, binder, curing agents, or a combination thereof with the first and second protein sources to form the mixture.

23. The method of claim 11, wherein the mixture comprises from about 5 to about 30% additional ingredients.
